(19) United States
(12) Patent Application Publication
(10) Pub. No.: US 2010/0254057 A1
(43) Pub. Date: Oct. 7, 2010

(54) OVERLOAD POWER CUT-OFF DEVICE AND METHOD THEREOF

(76) Inventor: Hsiao-Han Chen, Cyonglin Township (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/416,324

(22) Filed: Apr. 1, 2009

(51) Int. Cl. H02H 3/20; G08B 21/00

(52) U.S. Cl. 361/91.2; 361/91.1; 340/661

(57) ABSTRACT

An overload power cut-off device is provided in an electric auxiliary system for avoiding overload in the system. The device includes a current detecting unit, a voltage comparing unit, an alarm unit, and a power cut-off unit. The current detecting unit includes a sensor coupled to the loop of the system for detecting a loop current of the system so as to output a sensing signal corresponding to the loop current. The voltage comparing unit compares the voltage value of the sensing signal with a preset voltage value and a voltage value of a rated current for respectively outputting a first driving signal and a second driving signal. The alarm unit receives the first driving signal to generate an alarm signal. The power cut-off unit receives the second driving signal to output a power cut-off signal for cutting off the power supply loop of the electric auxiliary system.

### BACKGROUND OF THE INVENTION

1. Field of the Invention

The present invention relates to a power cut-off device and a method thereof, and more particularly to an overload power cut-off device and a method thereof.

2. Description of Related Art

A majority of socket expansion products or electrical appliances come with the design of including a self-recovery power-off protection device; the protection device will start cutting off a power supply loop to interrupt a power supply if a current passing through the protection device exceeds a specific value, so as to achieve the purpose of assuring the power safety of the socket expansion products or electrical appliances.

The most common power-off protection device is usually manufactured by using a bi-metallic strip, such that the heat produced after an overload current passes through the bi-metallic strip leads to the deforming of the bi-metallic strip, thereby tripping a protection switch and cut off a power supply loop. Therein, the power supply can be resumed by pressing a power-on switch again.

In the aforementioned design, if the power consumption approaches the rated current of the design, the protection device will not operate since the designed current rating has not been exceeded and overloading has not occurred. However, the power cord will be at a heat generating state due to the power consumption, and the produced heat will deteriorate the insulator of the power cord, thereby result in a higher risk of short circuit. Furthermore, the bi-metallic strip type overload protection breaker has a very serious problem in that the ambient temperature has a substantial effect on the breaker. If the ambient temperature is equal to 25° C. for example, there will be around ±25% error of the trip current when the ambient temperature falls within a range of 10° C.˜40° C. If the power cord is designed with a specification of the rated current, then it will require 1.25 times of current to trip the breaker, and the heat generation power of the power conducting wire will be approximately equal to 1.6 times of the design value, and thus accidents may occur easily.

In view of the foregoing shortcomings of the prior art, the inventor of the present invention disclosed the present invention to overcome the shortcomings of the prior art.

### SUMMARY OF THE INVENTION

Therefore, it is a primary objective of the present invention to overcome the shortcomings of the prior art by providing an overload power cut-off device and an overload power cut-off method, wherein the current value of a load is sensed and converted into a voltage type signal, and if the voltage value of this signal exceeds a preset voltage value, an alarm signal will be generated to remind users about the loop current approaching its load limit, and it is necessary to for the users to power off the electric device or remove the auxiliary power load. If the voltage value of the sensing signal is greater than the voltage value corresponding to the rated current of the loop, the power supply loop of the electric auxiliary system will be cut off to prevent possible accidents caused by an overload of the electric auxiliary system.

To achieve the foregoing objective, the present invention provides an overload power cut-off device installed at a load input terminal. The overload power cut-off device includes a current detecting unit, a voltage comparing unit, an alarm unit, and a power cut-off unit. The current detecting unit comprises a sensing element installed at a power supply loop for sensing a loop current of a power supply, and outputting a voltage type sensing signal according to the current value of the loop current; a voltage comparing unit coupled to the current detecting unit, for comparing a voltage value of the sensing signal with a preset voltage value so as to output a first driving signal, and comparing a voltage value of the sensing signal with a voltage value of a corresponding rated current so as to output a second driving signal; an alarm unit coupled to the voltage comparing unit, for receiving a control of the first driving signal so as to generate an alarm signal; a power cut-off unit coupled to the voltage comparing unit, for receiving the second driving signal to output a power cut-off signal so as to cut off the power supply loop of the electric auxiliary system.

The present invention further discloses an overload power cut-off method for preventing an overload, and the method comprises the steps of: providing a sensing element installed at a loop of an electric auxiliary system for sensing a loop current of the electric auxiliary system so as to output a current signal; converting the signal type of the current signal to a voltage signal; comparing the voltage value of the voltage signal with the voltage value of a rated current of the loop; and outputting a power cut-off signal to drive a power cut-off unit so as to cut off the power supply loop of the electric auxiliary system if the voltage value of the voltage signal exceeds the voltage value of the rated current of the loop.

With the detection method of using the sensing element installed at the power supply loop to sense the loop current of the load, the effect of the ambient temperature imposed on the breaker circuit can be reduced effectively, and the error of detecting a rated current of the loop in a temperature change range of 0° C.˜50° C. can be lowered to ±5% or even ±3%, and thus the present invention can enhance the power safety of the electric device substantially.

The above and other objects, features, and advantages of the present invention will become apparent from the following detailed description taken with the accompanying drawings.

### BRIEF DESCRIPTION OF THE DRAWINGS

FIG. 1 is a system block diagram of an overload power cut-off device in accordance with the present invention;

FIG. 2 is a perspective view of an overload power cut-off device in accordance with a preferred embodiment of the present invention;

FIG. 3 is a circuit diagram of the overload power cut-off device in accordance with the first preferred embodiment of the present invention;

FIG. 4 is a flow chart of an overload power cut-off method in accordance with the first preferred embodiment of the present invention;

FIG. 5 is a system block diagram of an overload power cut-off device in accordance with a second preferred embodiment of the present invention;

FIG. 6 is a circuit diagram of the overload power cut-off device in accordance with the second preferred embodiment of the present invention; and

FIG. 7 is a flow chart of an overload power cut-off method in accordance with the second preferred embodiment of the present invention.

### DETAILED DESCRIPTION OF THE PREFERRED EMBODIMENTS

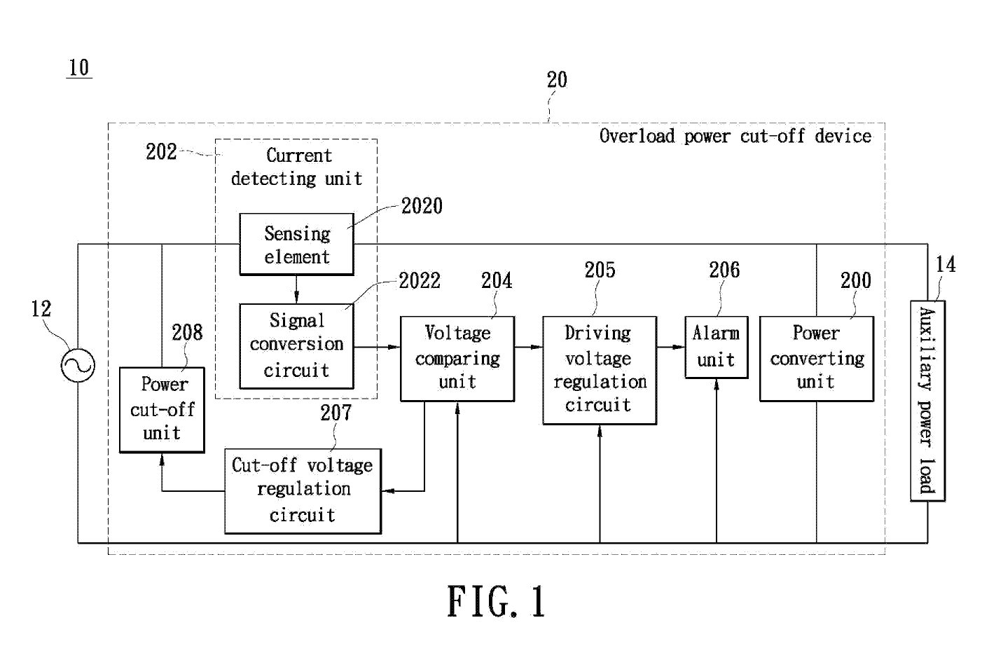

With reference to FIG. 1 for a system block diagram of an overload power cut-off device in accordance with the present invention, the overload power cut-off device 20 is installed at an input terminal of a load 14 coupled between an AC power 12 and the load 14. The AC power 12 is supplied from a utility power system, and the load 14 is composed of a single electric device or all electric devices that uses the same loop of the power supply to obtain electric power, and the electric devices obtain the power supply through a switch of the overload power cut-off device 20.

The overload power cut-off device 20 is intended for providing power safety and for reminding users to control the power consumption of the auxiliary power load 14. Therefore, a current limiting value of the auxiliary power load 14 is set according to a specific percentage (such as 80%˜85%) of a rated current of a loop, and the overload power cut-off device 20 detects the loop current of the auxiliary power load 14 continuously, and produces a warning sound or a warning light to remind users to turn off or reduce the loop current if the loop current exceeds the current limiting value, and the alarm signal will be terminated automatically until the loop current is lower than the current limiting value, so as to prevent possible accidents caused by an overload. If the power consumption of a circuit exceeds a rated current value (100%) of the auxiliary power load 14, then the power supply loop of the auxiliary power load 14 cuts off immediately. Therein, the power supply resumes if the user performs a restoration.

The overload power cut-off device 20 comprises a power converting unit 200, a detecting unit 202, a voltage comparing unit 204, a driving voltage regulation circuit 205, an alarm unit 206, a cut-off voltage regulation circuit 207, and a power cut-off unit 208. The detecting unit 202 comprises a sensing element 2020 and a signal conversion circuit 2022. The power converting unit 200 is coupled to a loop of the auxiliary power load 14 for obtaining AC power, and for converting the AC power into DC power to be supplied for use by the detecting unit 202, the voltage comparing unit 204, the driving voltage regulation circuit 205, the alarm unit 206, the cut-off voltage regulation circuit 207, and the power cut-off unit 208 in the overload power cut-off device 20.

The sensing element 2020 is a contactless sensing element or a contact sensing element. If the sensing element 2020 is a contact sensing element, the sensing element 2020 can be a resistor serially connected to the power supply loop, and its resistance value is below 10 mil If the sensing element 2020 is a contactless sensing element, the contactless sensing element can be a current transformer, a magnet-resistor set, or a Hall element set.

The sensing element 2020 is installed on a power control output line of the power supply loop. If the sensing element 2020 is a current transformer, a current signal is sensed when the current of the load 14 varies. The signal conversion circuit 2022 is coupled to the sensing element 2020 for converting a current signal into a voltage type sensing signal by a resistor with low resistance. On the other hand, if the sensing element 2020 is a resistor with extreme low resistance and serial in the power supply loop, and magnet-resistor set or a Hall element set, the output will be a voltage type sensing signal, and the signal conversion circuit 2022 is designed for amplifying and filtering the sensing signal. However, the Hall element set or magnet-resistor set generally comes with an electric bridge structure, and thus the signal conversion circuit 2022 usually adopts the design of a differential type amplifier.

The voltage comparing unit 204 is coupled to a detecting unit 202 for comparing the voltage value of a sensing signal with a preset voltage value to output a first driving signal, and for comparing the voltage value of the sensing signal with the magnitude of the voltage signal corresponding to a rated current so as to output a second driving signal. The driving voltage regulation circuit 205 and the cut-off voltage regulation circuit 207 are coupled to the voltage comparing unit 204 for stabilizing the pulse-type first driving signal and second driving signal converted by the stable voltage comparing unit 204 into a stable DC voltage signal.

The alarm unit 206 is coupled to the driving voltage regulation circuit 205 for receiving and being controlled according to the first driving signal so to generate an alarm signal. The power cut-off unit 208 is coupled to the cut-off voltage regulation circuit 207 for receiving a second driving signal and outputting a power cut-off signal so as to cut off the power supply loop.

The preset voltage value is set according to a current limiting value of the load 14, and its setup will be described below. The alarm unit 206 comprises at least one warning element, which can be a sound effect element such as a buzzer or a speaker, or a light emitting element such as a lamp or a light emitting diode so as to produce a warning sound and/or a warning light.

If the loop current is measured in a loop serially connected to a precision resistor with an extreme low resistance value, and a loop current value is obtained by a voltage difference between both terminals of the resistor, then a more accurate result can be obtained, however the power loss will be greater. On the other hand, the method adopting a coupling device has a less accurate result, but a more advantageous power loss.

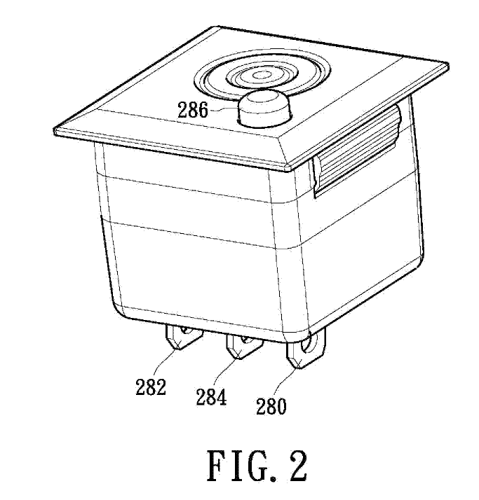

With reference to FIG. 2 for a schematic view of an appearance of an overload power cut-off device in accordance with a preferred embodiment of the present invention and a more specific illustration of the concept of the present invention, the overload power cut-off device 20 comprises a power input pin 280(N), a power control input pin 282(L), and a power control output pin 284(L′) installed at input of the auxiliary power load 14 by wire soldering or on board insertion soldering, and a press button 286 is provided for directly powering on/off a control device. The power converting unit 200, the current detecting unit 202, the voltage comparing unit 204, the driving voltage regulation circuit 20, the alarm unit 206, the cut-off voltage regulation circuit 207, and the power cut-off unit 208 are installed in the overload power cut-off device for detecting a loop current.

With reference to FIGS. 1 to 3, FIG. 3 shows a circuit diagram of an overload power cut-off device in accordance with a first preferred embodiment of the present invention to further illustrate the invention as follows.

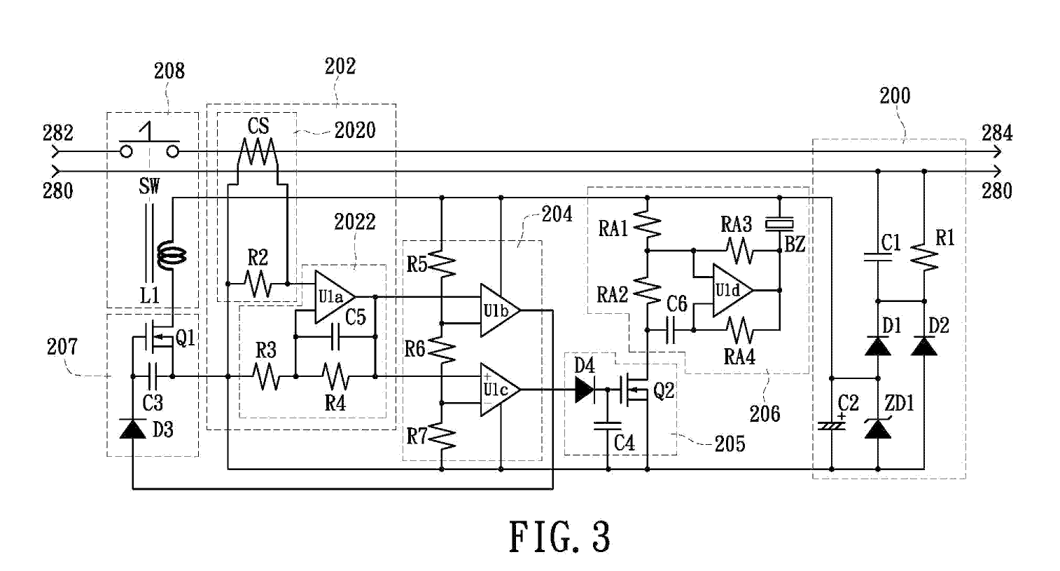

In FIG. 3, the power converting unit 200 is a rectifier circuit comprising a resistor R1, two capacitors C1˜C2, two diodes D1˜D2, and a Zener diode ZD1 for converting AC power into DC power for the overload power cut-off device 20. In the current detecting unit 202, a sensing element 2020 is installed between a power cut-off unit 208 and a power control output pin 284. In FIG. 3, the sensing element 2020 of this preferred embodiment is a contactless sensing element comprising a current transformer CS and a resistor R2. Of course, the sensing element 2020 can be substituted by a precision resistor R2, or a magnet-resistor set, or a Hall element set, wherein the precision resistor R2 with an extreme low resistance value is serial between the power cut-off unit 208 and the power control output pin 284. The sensing element 2020 senses a loop current passing through the conducting wire to generate an AC signal corresponding to the loop current. The signal conversion circuit 2022 is coupled to the sensing element 2020, and the signal conversion circuit 2022 is composed of an amplifier U1a, resistors R3˜R4, and a capacitor C3 for generating a filtered and amplified voltage signal so as to output a voltage sensing signal.

The voltage comparing unit 204 comprises a first comparison circuit and a second comparison circuit, wherein the first comparison circuit is an amplifier U1c and the second comparison circuit is an amplifier U1b. An input terminal of the amplifier U1c obtains a reference voltage by dividing the voltage by the resistors (R5+R6) and R7 and an input terminal of the amplifier U1b obtains a reference voltage, the voltage value correspond to the rated current of the loop, by dividing the voltage by the resistors R5 and (R6+R7). Another input terminal coupled to the amplifier U1b and the amplifier U1c is connected to an output terminal of the amplifier U1a. If the voltage value of the voltage signal exceeds the reference voltage value of the amplifier U1c, the amplifier U1c outputs a first driving signal to the driving voltage regulation circuit 205. If the detected voltage value of the voltage signal exceeds the reference voltage value of the amplifier U1b, the amplifier U1b outputs a second driving signal to the cut-off voltage regulation circuit 207.

The driving voltage regulation circuit 205 is comprised of a diode D4, a capacitor C4 and a MOSFET Q2 for stabilizing a pulse type first driving signal outputted by the comparing unit 204 at a constant high or low DC by means of a one-way charging of the diode D4 and the capacitor C4, and a switching of the MOSFET Q2. The-cut-off voltage regulation circuit 207 is comprised of a diode D3, a capacitor C3, and a MOSFET Q1 for stabilizing a pulse type second driving signal outputted by the comparing unit 204 at a constant high or low DC through a one-way charging of the diode D3 and capacitor C3, and a switching of the MOSFET Q1.

The alarm unit 206 comprises a buzzer BZ and an oscillation signal generating circuit. The oscillation signal generating circuit is comprised of an amplifier U1d, resistors RA1˜RA4, and a capacitor C6 for receiving a stable DC voltage type first driving signal outputted from the driving voltage regulation circuit 205 so as to generate an oscillation signal and drive the buzzer BZ to output a warning sound.

The power cut-off unit 208 is comprised of an electromagnet L1 and a power switch SW. If a stable voltage type second driving signal outputted by the cut-off voltage regulation circuit 207 is received, a mechanical movement produced by the attraction of the electromagnet L1 is then used for cutting off the power supply loop of the load.

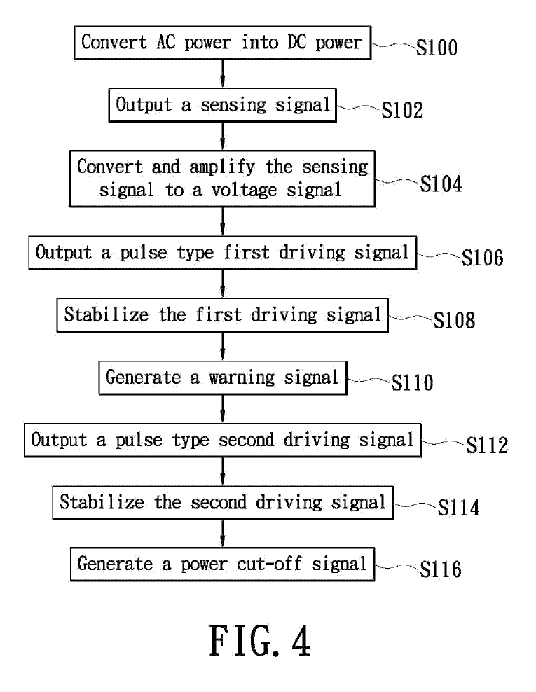

The overload power cut-off device 20 can be achieved by various different circuits. For example, the function of the power converting unit 200 can be achieved by using other AC/DC conversion circuits or directly using a battery for supplying the DC power required by the overload power cut-off device 20, in addition to the rectifier circuit as mentioned above. In the voltage comparing unit 204 as shown in FIG. 3, the current detecting unit 202 converts the current signal into a voltage signal and transmits the voltage signal to the voltage comparing unit 204 for control purpose. However, persons of ordinarily skilled in the art can use other circuit structures to stabilize the amplified sensing signal and compare the voltage. The related circuit of the alarm unit 206 is designed according to the warning element, and the oscillation signal generating circuit as shown in FIG. 4 is applicable for a buzzer that is not built in the drive circuit. If the buzzer is built in the drive circuit, then it is not necessary to have the external oscillation signal generating circuit. If a light emitting element is used as the warning element, the alarm unit 206 is designed according to the drive circuit of the optical device to drive the warning light produced between the light emitting devices. In addition, the main circuits of the overload power cut-off device 20 can be fabricated onto a single chip by an integrated circuit technology for simplifying the production process. FIG. 3 only shows an example of circuits of the overload warning device for illustrating the operating mechanism of the present invention, but the scope of the invention is not limited to such arrangement only.

With reference to FIGS. 1, 3, and 4 for an overload power cut-off method for an electric auxiliary system, FIG. 4 shows a flow chart of an overload power cut-off method in accordance with the first preferred embodiment of the present invention.

The overload power cut-off method is applicable for preventing an overload of a load 14, and a switch of an overload power cut-off device 20 is switched to connect an AC power 12 distributed by an AC utility power system. Firstly, the overload power cut-off device 20 obtains an AC power 12 from the electric auxiliary system, and then a power converting unit 200 converts the AC power 12 into a DC voltage (S100). A sensing element 2020 is installed at the power supply loop for outputting a sensing signal (S102). A circuit converts and amplifies the sensing signal to a voltage signal (S104).

If an amplifier U1c compares and determines that the detected voltage value of the voltage signal is greater than a reference voltage value, then the amplifier U1c will output a pulse type first driving signal (S106), and then the first driving signal will be transmitted to a driving voltage regulation circuit 205 so as to perform a stabilization upon the first driving signal (S108), and the first driving signal having a stable DC voltage signal will be outputted to drive an alarm unit 206 to generate a warning signal (S110). Meanwhile, if an amplifier U1b compares and determines that the detected voltage value of the voltage signal is greater than the reference voltage value, then a pulse type second driving signal will be outputted (S112), and the second driving signal will be transmitted to a cut-off voltage regulation circuit 207 so as to perform a stabilization upon the second driving signal (S114), and the second driving signal having a stable DC voltage signal will be outputted to drive a power cut-off unit 208 to generate a power cut-off signal so as to cut off a power supply loop (S116).

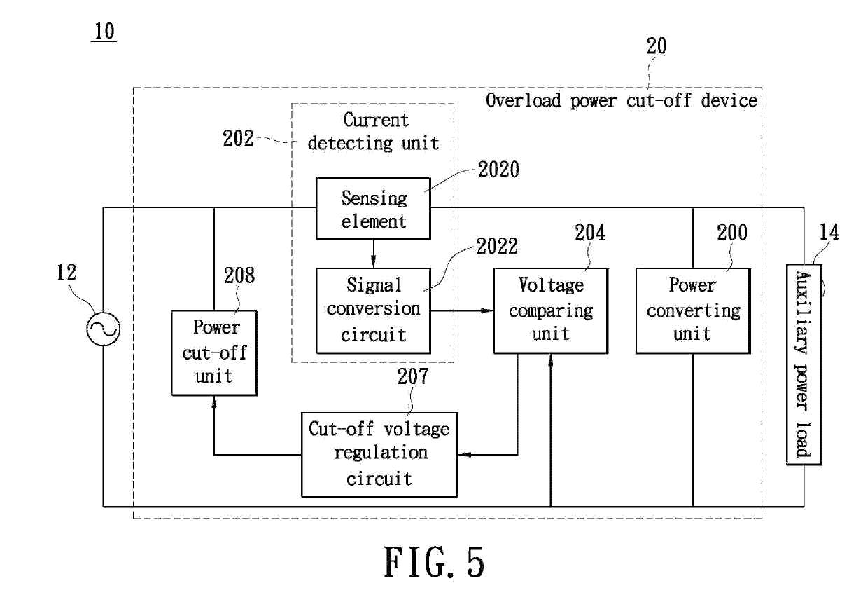

With reference to FIG. 5 for a system block diagram of an overload power cut-off device in accordance with a second preferred embodiment of the present invention, the overload power cut-off device 20 of the second preferred embodiment differs from the first preferred embodiment by omitting the alarm unit 206, so that when the voltage comparing unit 204 compares the voltage value of the sensing signal with the voltage value of the rated current, a driving signal is outputted. The power cut-off unit 208 is coupled to the voltage comparing unit 204 for receiving the driving signal and outputting the power cut-off signal so as to cut off the power supply loop of the electric auxiliary system 10.

With reference to FIGS. 3, 5 and 6, FIG. 6 shows a circuit diagram of an overload power cut-off device in accordance with the second preferred embodiment of the present invention for further illustrating the invention.

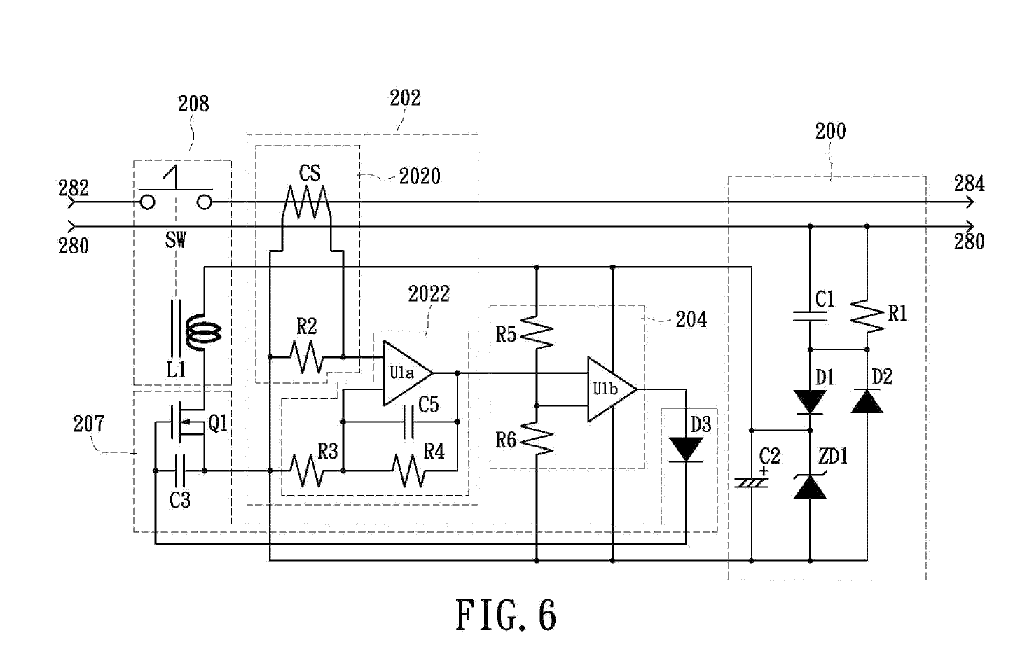

In FIG. 6, the internal components and operation methods of a power converting unit 200 and a current detecting unit 202 are the same as those disclosed in the first preferred embodiment, and thus will not be described here again.

The voltage comparing unit 204 is a comparison circuit which can be an amplifier U1b having an input terminal used as an input source of a detected voltage, and a reference voltage at another input terminal of the amplifier U1b is obtained by dividing the voltage by resistors R5, R6, which is the voltage value of the rated current of the loop. If the amplifier U1b compares and determines that the voltage value of the voltage signal exceeds a reference voltage value, then the amplifier U1b will output a pulse type driving signal so as to a cut-off voltage regulation circuit 207.

The internal components of the cut-off voltage regulation circuit 207 and the power cut-off unit 208 and their operation method are the same as those disclosed in the first preferred embodiment, and thus will not be described here again.

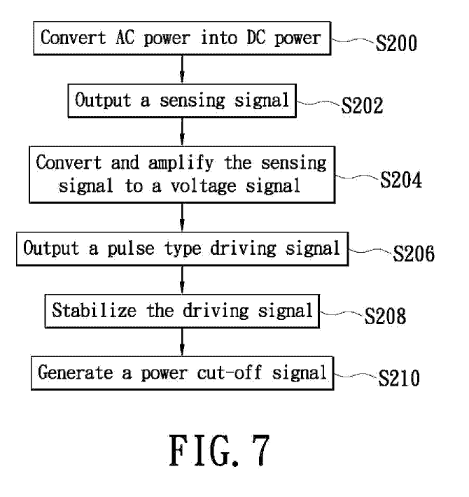

With reference to FIGS. 5 to 7 for the concept of an overload power cut-off method of an electric auxiliary system in accordance with the present invention, FIG. 7 shows a flow chart of an overload power cut-off method in accordance with the second preferred embodiment of the present invention.

The overload power cut-off method is applicable for preventing an overload of a load 14, and the load 14 is connected to an AC power 12 by switching on an overload power cut-off device 20, and the AC power 12 is distributed from an AC utility power system. Firstly, the overload power cut-off device 20 obtains an AC power 12 from a power supply loop, and then a power converting unit 200 converts the AC power 12 into a DC voltage (S200). A sensing element 2020 installed on the power supply loop outputs a sensing signal (S202), and a circuit converts the sensing signal (which is in current) and amplifies the type of the sensing signal to a voltage signal (S204).

In Step (S204), the basic gain determine by resistors R3˜R4. A capacitor C5 will filter noises in a high frequency signal, and the amplifier U1a will output an amplified AC positive half wave voltage signal. The amplified AC positive half wave voltage signal is transmitted to an input terminal of an amplifier U1b, and another input terminal of the amplifier U1b is connected to resistors R5, R6 for obtaining the required reference voltage.

If the amplifier U1b compares and determines that the detected voltage value of the voltage signal is greater than the reference voltage value, then a pulse type driving signal will be outputted (S206), and then the driving signal will be maintained by a one-way charging through a diode D3 and a capacitor C3 of a cut-off voltage regulation circuit 207, and the switch of a MOSFET Q1 so as to stabilize a pulse type driving signal outputted from the voltage comparing unit 204 at a high or low DC. Then, the pulse type driving signal that has been stabilized is outputted to a power cut-off unit 208 (S208), and drives the power cut-off unit 208 to generate a power cut-off signal so as to cut off the power supply loop of the electric auxiliary system (S210).

In summation of the overload power cut-off device and the overload power cut-off method of the present invention as described, the power cut-off unit of the invention is turned on so as to cut off the power supply loop of the electric auxiliary system for preventing possible accidents caused by a power overload if the consumption of current of a load exceeds the rated current value of the electric auxiliary system.

Although the present invention has been described with reference to the preferred embodiments thereof, it will be understood that the present invention is not limited to the details thereof. Various substitutions and modifications have been suggested in the foregoing description, and others will occur to those of ordinary skill in the art. Therefore, all such substitutions and modifications are intended to be embraced within the scope of the present invention as defined in the appended claims.

What is claimed is:

1. An overload power cut-off device for an electric auxiliary system, comprising:
a detecting unit, including a sensing element installed on a power supply loop of the electric auxiliary system, for outputting a voltage type sensing signal;
a voltage comparing unit, coupled to the detecting unit, for comparing the voltage value of the sensing signal with a preset voltage value so as to output a first driving signal, and comparing the voltage value of the sensing signal with the voltage value corresponding to a rated current of the loop so as to output a second driving signal;
an alarm unit, coupled to the voltage comparing unit, for receiving a control of the first driving signal so as to generate an alarm signal; and
a power cut-off unit, coupled to the voltage comparing unit, for receiving the second driving signal, and outputting a power cut-off signal so as to cut off the power supply loop.

2. The overload power cut-off device of claim 1, wherein the sensing element is a contactless sensing element or a contact sensing element;
the contact sensing element is a resistor;
the contactless sensing element is a sensing element selected from the collection of a current transformer, a magnet-resistor set, and a Hall element set.

3. The overload power cut-off device of claim 2, wherein the detecting unit further comprises a signal conversion circuit for generating a filtered and amplified voltage signal according to the loop current of the power supply loop.

4. The overload power cut-off device of claim 1, wherein the voltage comparing unit further comprises:
a first comparison circuit, coupled to the detecting unit, for comparing the voltage signal of the sensing signal with the preset voltage value to output the first driving signal; and
a second comparison circuit, coupled to the detecting unit, for comparing the voltage value of the sensing signal with the voltage value of the rated current of the loop so as to output the second driving signal.

5. The overload power cut-off device of claim 4, further comprising:
a driving voltage regulation circuit, coupled to the voltage comparing unit, for
converting the first driving signal into a stable DC voltage signal; and
a cut-off voltage regulation circuit, coupled to the voltage comparing unit, for converting the second driving signal into a stable DC voltage signal.

6. An overload power cut-off method, applicable for preventing a power overload of an electric auxiliary system, and the method comprising the steps of:
providing a sensing element installed at a power supply loop of the electric auxiliary system, for outputting a sensing signal;
converting and amplifying the sensing signal to a voltage signal;
comparing a voltage value of the voltage signal with a preset voltage value;
driving an alarm unit to produce a warning signal if the voltage value of the voltage signal exceeds the preset voltage value;
comparing the voltage value of the voltage signal with the voltage value of a rated current of the loop; and
outputting a power cut-off signal to drive a power cut-off unit so as to cut off the power supply loop of the electric auxiliary system, if the voltage value of the voltage signal exceeds the voltage value of the rated current of the loop.

7. The overload power cut-off method of claim 6, wherein the step of comparing the voltage value of the voltage signal with the voltage value of the rated current of the loop further comprises the steps of amplifying the voltage signal and outputting the voltage signal as the power cut-off signal after a stabilization is executed.

8. An overload power cut-off device for an electric auxiliary system, installed at a load input terminal, comprising:
a detecting unit, including a sensing element installed on a power supply loop of the electric auxiliary system, for outputting a voltage type sensing signal;
a voltage comparing unit, coupled to the detecting unit, for comparing the voltage value of the sensing signal with the voltage value corresponding to a rated current of the loop so as to output a driving signal; and
a power cut-off unit, coupled to the voltage comparing unit, for receiving the driving signal, and outputting a power cut-off signal so as to cut off the power supply loop.

9. The overload power cut-off device of claim 8, wherein the sensing element is a contactless sensing element or a contact sensing element;
the contact sensing element is a resistor;
the contactless sensing element is a sensing element selected from the collection of a current transformer, a magnet-resistor set, and a Hall element set.

10. The overload power cut-off device of claim 9, wherein the detecting unit further comprises a signal conversion circuit for generating a filtered and amplified voltage signal according to the loop current of the power supply loop.

11. The overload power cut-off device of claim 8, wherein the voltage comparing unit further comprises:
a comparison circuit, coupled to the detecting unit, for comparing the voltage signal of the sensing signal with the voltage value of the rated current of the loop so as to output the driving signal.

12. The overload power cut-off device of claim 11, further comprising:
a cut-off voltage regulation circuit, coupled to the voltage comparing unit, for converting the driving signal into a stable DC voltage signal.

13. An overload power cut-off method, applicable for preventing an overload of an electric auxiliary system, and the method comprising the steps of:
providing a sensing element installed on a power supply loop of the electric auxiliary system for outputting a sensing signal;
converting and amplifying the sensing signal to a voltage signal;
comparing the voltage value of the voltage signal with the voltage value of a rated current of the loop; and
outputting a power cut-off signal to drive a power cut-off unit so as to cut off the power supply loop of the electric auxiliary system, if the voltage value of the voltage signal exceeds the voltage value of the rated current of the loop.

14. The overload power cut-off method of claim 13, wherein the step of comparing the voltage value of the voltage signal with the voltage value of the rated current of the loop further comprises the step of amplifying the voltage signal and outputting the voltage signal as the power cut-off signal after a stabilization is executed.

15. The overload power cut-off device of claim 3, wherein the voltage comparing unit further comprises:
a first comparison circuit, coupled to the detecting unit, for comparing the voltage signal of the sensing signal with the preset voltage value to output the first driving signal; and
a second comparison circuit, coupled to the detecting unit, for comparing the voltage value of the sensing signal with the voltage value of the rated current of the loop so as to output the second driving signal.

16. The overload power cut-off device of claim 10, wherein the voltage comparing unit further comprises:
a comparison circuit, coupled to the detecting unit, for comparing the voltage signal of the sensing signal with the voltage value of the rated current of the loop so as to output the driving signal.
